(19) United States
(12) Patent Application Publication
(10) Pub. No.: US 2004/0076475 A1
(43) Pub. Date: Apr. 22, 2004

(54) Waste processing method

(76) Inventor: Stanley Peter Bell, Abbots Bromley (GB)

Correspondence Address: Davis Wright Tremaine, Suite 2600, 1501 Fourth Avenue, Seattle, WA, 98101-1688, US

(21) Appl. No.: 10/380,504

(22) PCT Filed: Aug. 31, 2001
(86) PCT No.: PCT/GB01/03911

(30) Foreign Application Priority Data
Sep. 14, 2000 (GB) 0022629.0

(51) Int. Cl. B09B 1/00; G21F 9/00; E02D 31/00

(52) U.S. Cl. 405/129.45; 405/129.1; 405/129.2

(57) ABSTRACT

The present invention relates to a method of processing biodegradable waste material comprising the steps of: (i) placing said waste material in a container, (ii) adding soil containing bacteria to said waste material, (iii) applying liquid to said waste material, and (iv) periodically aerating said waste material, whereby to biodegrade said waste material to a soil material.

The present invention relates to a method of processing biodegradable waste material, and more particularly to a method of biodegrading said waste material.

Disposal of waste is increasingly becoming a major problem. Despite efforts to recycle certain metals, plastics, glass and paper, most municipal, commercial and industrial solid waste is either incinerated (thereby polluting the atmosphere and contributing to global warming) or simply buried in land fill sites. Neither of these strategies is satisfactory. In particular, the continued use of land fill sites is not sustainable long term, since in most developed countries there is a diminishing source of land for their creation. In current land fill sites, even waste material capable of biodegradation (making up between 20 and 45% of household waste) generally shows little degradation, even after several years.

On a small scale, plant-based food waste material and biodegradable garden waste can be composted. The waste is placed in a container and covered to maintain the temperature within the container and to shelter the material from rain. After several months, a friable composting material is obtained. The process is slow, and is only suitable for a limited range of waste materials.

It is an object of the present invention to provide an alternative to current methods of waste disposal which obviates or mitigates the above-mentioned problems.

According to the present invention there is provided a method of processing biodegradable waste material comprising the steps of:

(i) placing said waste material in a container,

(ii) adding soil containing bacteria to said waste material,

(iii) applying liquid to said waste material, and

(iv) periodically aerating said waste material,

whereby to biodegrade said waste material to a soil material.

As used herein, “biodegradable waste material” is intended to include household, commercial and industrial solid biodegradable waste which may comprise, inter alia, plant and vegetable material, cooked meat-based products as well as paper-based products (eg. newspapers and cardboard packaging).

It will be understood that biodegradation is effected by bacteria contained within the soil. Said aeration step (iv) ensures that the process is primarily aerobic in nature. As a result, substantially no methane gas is produced (or its associated odour).

Preferably, step (i) is effected by digging a hole in the ground, the ground surrounding the hole serving as the container. In an alternative embodiment, a rotatable open-ended tube serves as the container, in which case step (iv) is preferably effected by periodic (or continuous) rotation of the container.

Preferably, the method includes an initial step of separating the biodegradable waste material from non-biodegradable material such as metals, glass and plastics. Advantageously, no further separation of the biodegradable material is required. Small amounts of raw meat products may be present in the waste material without adversely affecting the process.

Preferably, prior to step (i), the method includes a step of mechanically comminuting or macerating the waste material. Examples of such mechanical comminuting include shredding, grinding and pulverising. Examples of maceration include pulping (requiring addition of liquid). It will be understood that such treatment promotes more rapid biodegradation of the waste material by increasing the surface area of the waste material and by breaking up fibres which bind the waste material together.

Preferably, the comminution step is carried out until substantially all the waste material is reduced to a particle size of no more than 5 cm.

Step (ii) may be effected by mixing soil into the waste material and/or covering the waste material with soil. Preferably, the ratio of soil added to waste material is about 1:5.

Preferably, step (iv) is achieved by physically turning the waste material, for example by forking.

In a preferred embodiment the waste material is placed in a trench, trough or furrow in the ground and step (iv) is effected by ploughing with an offset plough. It will be understood that each ploughing run turns the waste material over, and also displaces the waste material laterally of the initial trench or furrow. Alternatively, step (iv) may be effected using other mechanical devices, such as a spading machine. When a spading machine is used, the waste material is mixed, but is substantially retained in its initial trench or furrow.

Preferably, the method also includes a step of providing to the waste material at least one feedstock containing nutrients and/or substrates for the soil bacteria. Examples of suitable feedstocks include effluent or waste from food, beer or soft drink production, farmyard waste (eg. horse manure, chicken litter, pig excrement), treated sewage, sugar or starch containing solutions, effluent from the paper industry, pulped food wastes, yeast containing solutions, vegetable peelings from the food industry and other biodegradable food wastes, methanol, ethanol, other alcohols and waste organic chemicals. Said feedstock may be added as a liquid, or as a solid (eg. pelletised).

More preferably, the feedstock is a sugar containing solution such as beer or soft drink (eg. lemonade).

Step (iii) may be effected during the comminution step (when present), or before, during or after step (ii). Preferably, step (iii) is effected before step (ii). The liquid applied in step (iii) is preferably an aqueous liquid which may contain methanol, ethanol or other alcohols or liquid organic chemicals which serve as substrates for the soil bacteria. The aqueous liquid may also be sour, stagnant or otherwise contaminated water.

More preferably, however, the liquid applied in step (iii) is one or more of water, a sugar- or starch-containing solution, a nitrogen containing solution, beer, soft drink or effluent from the paper industry. Conveniently, the feeding step and step (iii) can be effected as a single step, i.e. the feedstock is provided in liquid form. In a particularly convenient embodiment the maceration of the waste material, step (iii) and the feeding step are carried out in a single operation by pulping the waste material with the feedstock in liquid form.

Preferably, the liquid content of the waste material is maintained within predetermined limits during the process by periodic addition of the liquid and/or feedstock in liquid form. More preferably, the liquid content is at least 40% by weight of the dry waste material but less than the amount required to saturate the waste material (saturation being observable by waterlogging or free standing water throughout the waste material mass). Most preferably, the liquid content is in the range of from 40 to 60% by weight of the dry waste material.

Preferably, the pH of the biodegrading waste material is maintained within the range of from 4.5 to 9 and more preferably from pH 6 to 8. At a pH lower than 4.5, the biodegradation tends to become anaerobic and methane and unpleasant odours are produced.

Embodiments of the invention will now be described by way of example only.

### EXAMPLE 1

A furrow 20 cm wide, 2 metres long and 20 cm deep was dug in soil and shredded household waste material (50 Kg, obtained from Greater Manchester Waste Authority), having had substantially all metal, plastics and glass removed was laid in the furrow. The waste material was then sprayed with a feedstock consisting of 20 Kg aqueous sugar solution (0.25 kg sugar /l) and covered with the soil dug from the furrow. The volume of waste was such that it only partly filled the furrow, so that when covered with soil, the furrow was filled and level with the surrounding soil surface. The soil covering reduces any odours produced by the biodegradation process and provides the bacteria necessary for degradation of the waste material.

After approximately 24 hrs, liquid (water, 10 Kg) was applied to the soil covering the waste material and the waste material was turned with a garden fork, thereby promoting aerobic digestion of the waste material by the soil bacteria. The watering and turning steps were repeated every 24 hrs for 7 days. After each turning, a sample of the waste material was taken to monitor its state of degradation.

The results were as follows:

| Time | degradation¹ |
|---|---|
| 1 day | 0% |
| 2 days | 5% |
| 3 days | 50% |
| 4 days | 60% |
| 5 days | 75% |
| 6 days | 80% |
| 7 days | 95% |

¹As determined by visual inspection

Similar results were obtained when the waste material was sprayed with waste beer or waste soft drink as the feedstock.

### EXAMPLE 2

The method of Example 1 was repeated, except that the watering step was effected using the sugar solution (10 Kg) (i.e. combined liquid addition and feed). In addition, the watering and thorough turning was carried out every 8 hours. Degradation was 95% complete after 60 hours.

### EXAMPLE 3

Example 1 was repeated, except that water was used as liquid and feedstock. Conversion to a soil material was substantially complete (>95 %) after 14 days.

### EXAMPLE 4

A 1 hectare field (200m×50m) is ploughed along its length to create a series of parallel 200m furrows approximately 45 cm deep. Into the bottom of furrows along a first side of the field is distributed shredded household waste material (120 tonnes), having had substantially all metal, plastics and glass removed. The partly filled furrows are then covered with soil to a depth of at least 3 cm before watering with waste beer. After 24 hours, the waste material is rewatered with waste beer and the furrows containing the waste material ploughed with an offset plough which serves to aerate the waste material and move the waste material away from the first side of the field towards an opposite second side. The ploughing also creates new furrows along the first side of the field. These are partly filled with fresh household waste (120 tonnes) and the above process repeated.

It will be understood that each time the field is ploughed the waste material is being aerated and moved towards the second edge of the field as degradation occurs. At the second edge of the field it can be collected and removed for use elsewhere. The process operates on a continuous basis with waste supplied at the first side of the field and converted soil material being removed at the opposite second side of the field approximately 100 days later. In one year, a process operated in the manner described is capable of biodegrading over 40,000 tonnes of biodegradable waste in one year.

In a variation of Example 4, waste material is deposited into all the furrows in the ploughed field, and the aeration step is achieved using a spading machine. Spading machines are known in the horticultural art and generally comprise a number of spading arms mounted on an axle. The arms are arranged in a common (vertical) plane perpendicular to the (horizontal) axis of rotation of the axle. In use, the axle is rotated and the spading arms dig into the ground mixing the waste material into the soil. In contrast to the use of an offset plough, there is no net lateral movement of degrading material across the field, so that the process is a batch process rather than a continuous one.

### COMPARATIVE EXAMPLE 1

The method of Example 1 was repeated except that no feedstock or liquid was applied to the waste material. Only minimal decomposition (<10%) had occurred even after 1 month. In completely dry conditions, no biodegradation occurs even after several years.

### COMPARATIVE EXAMPLE 2

Example 1 was repeated except the turning steps were omitted. The waste material was eventually biodegraded to a compost material (after several months).

It will be understood that the specific length of time required for degradation will depend upon prevailing conditions. For example, ambient temperature of the soil will affect the rate of degradation by the bacteria. In colder climates it may be desirable to accelerate degradation by warming the liquid and/or feedstock solution applied to the waste material. However, it should be noted that the degradation process generates heat and that the soil covering acts as an insulating layer. Thus, warming of any liquid applied to the waste may only be required to accelerate the initial degradation process, or it may not be required at all.

The moisture content of the biodegrading waste material is also important for optimisation of the process. Too much or too little liquid results in a slowing of the process. The liquid content of the waste material can be monitored by sampling the waste material at intervals during the process. The amount of liquid added can be varied accordingly.

It may be desirable to monitor/adjust other parameters during the process, such as the carbon/nitrogen ratio of the biodegrading waste.

To accelerate the rate of degradation even further, additional bacteria and/or insect attractants (eg. musk, beetle and/or woodlice pheromones) may be added to the waste material.

The degraded product of the process is a soil material suitable for growing field crops (where legislation allows), trees and grass, and as a mulching material. The product of the process may also be suitable for use as a composting material, although it might be necessary to add certain nutrients such as nitrogen to meet the legal definition of compost in certain countries.

The present invention mitigates the problem of large volumes of household waste going to landfill or incineration. This has a positive contribution to the environment in several ways. Less land is required for landfill sites and less ash and other pollutants (such as greenhouse gases) are produced by incineration. The material being incinerated will also be enriched in plastics having a higher calorific value. In addition, the use of liquid waste to feed and/or water the solid waste material also results in degradation of the liquid waste, which would otherwise be neutralised and poured into the sewer system or directly into rivers. The ability to degrade alcohols and other chemical pollutants is a particular advantage.

1. A method of processing biodegradable waste material comprising the steps of:
(i) placing said waste material in a container,
(ii) adding soil containing bacteria to said waste material,
(iii) applying liquid to said waste material, and
(iv) periodically aerating said waste material,
whereby to biodegrade said waste material to a soil material.

2. A method as claimed in claim 1, wherein step (iv) is achieved by physically turning the waste material, for example by forking.

3. A method as claimed in claim 1 or 2, wherein step (i) is effected by digging a hole in the ground, the ground surrounding the hole serving as the container of step (i).

4. A method as claimed in claim 3, wherein the waste material is placed in a trench, trough or furrow in the ground and step (iv) is effected using a plough, offset plough or spading machine.

5. A method as claimed in claim 1, wherein a rotatable open-ended tube serves as the container of step (i), step (iv) being effected by periodic or continuous rotation of the container.

6. A method as claimed in any preceding claim, including an initial step of separating the biodegradable waste material from non-biodegradable material such as metals, glass and plastics.

7. A method as claimed in any preceding claim, including a step of mechanically comminuting or macerating the waste material prior to step (i).

8. A method as claimed in claim 7, wherein the comminution step is carried out until substantially all the waste material is reduced to a particle size of no more than 5 cm.

9. A method as claimed in any preceding claim, wherein step (ii) is effected by mixing soil into the waste material and/or covering the waste material with soil.

10. A method as claimed in claim 8, wherein the ratio of soil added to waste material is about 1:5.

11. A method as claimed in any preceding claim, including a step of providing to the waste material at least one feedstock containing nutrients and/or substrates for the soil bacteria.

12. A method as claimed in claim 11, wherein the feeding step and step (iii) are effected as a single step.

13. A method as claimed in claim 12, wherein said feedstock is selected from one or more of the group consisting of effluent or waste from food, beer or soft drink production; farmyard waste such as horse manure, chicken litter and pig excrement; treated sewage; sugar or starch containing solutions; effluent from the paper industry; pulped food wastes; yeast containing solutions; vegetable peelings from the food industry and other biodegradable food wastes; methanol, ethanol and other alcohols and waste organic chemicals.

14. A method as claimed in claim 13, wherein said feedstock is a sugar containing solution such as beer or soft drink.

15. A method as claimed in any preceding claim, wherein step (iii) is effected before step (ii).

16. A method as claimed in any preceding claim, wherein said liquid applied in step (iii) is an aqueous liquid which optionally contains methanol, ethanol or other alcohols or liquid organic chemicals which serve as substrates for the soil bacteria.

17. A method as claimed in any preceding claim, wherein the liquid applied in step (iii) is one or more of water, a sugar- or starch-containing solution, a nitrogen containing solution, beer, soft drink or effluent from the paper industry.

18. A method as claimed in any preceding claim, wherein the liquid content of the waste material is maintained within predetermined limits during the process by periodic addition of the liquid and/or feedstock in liquid form.

19. A method as claimed in claim 18, wherein the liquid content is at least 40% by weight of the dry waste material but less than the amount required to saturate the waste material.

20. A method as claimed in claim 18, wherein the liquid content is in the range of from 40 to 60% by weight of the dry waste material.

21. A method as claimed in any preceding claim, wherein the pH of the biodegrading waste material is maintained within the range of from 4.5 to 9 and more preferably from pH 6 to 8.
